(19) United States
(12) Patent Application Publication
(10) Pub. No.: US 2022/0317266 A1
(43) Pub. Date: Oct. 6, 2022

(54) RANGING DEVICE AND METHOD FOR DETERMINING DISTANCE

(71) Applicants: Yuji KIMURA, Tokyo (JP); Toyoki TANAKA, Tokyo (JP); Takahiko NISHIYAMA, Tokyo (JP); Kensuke YAMADA, Tokyo (JP)

(72) Inventors: Yuji KIMURA, Tokyo (JP); Toyoki TANAKA, Tokyo (JP); Takahiko NISHIYAMA, Tokyo (JP); Kensuke YAMADA, Tokyo (JP)

(73) Assignee: MITSUMI ELECTRIC CO., LTD., Tokyo (JP)

(21) Appl. No.: 17/652,178

(22) Filed: Feb. 23, 2022

(30) Foreign Application Priority Data
Mar. 30, 2021 (JP) 2021-056543

(51) Int. Cl. G01S 7/4865; G01S 7/481; G01S 17/931; G01S 17/10

(52) U.S. Cl. CPC G01S 7/4865; G01S 7/4814; G01S 7/4817; G01S 17/931; G01S 17/10

(57) ABSTRACT

A ranging device includes a light emitting circuit configured to emit light and a splitter configured to split the light into multiple beams. The ranging device includes a scanning circuit configured to perform scanning in two axial directions while aiming the multiple beams toward an emission area. The ranging device includes multiple light receiving circuits configured to respectively receive beams obtained from the multiple beams that are reflected or scattered by an object existing in the emission area, the light receiving circuits being configured to respectively output light reception signals. The ranging device includes a distance-information outputting circuit configured to output distance information about the object, the distance information being obtained based on each of the light reception signals that is output from a corresponding light receiving circuit among the multiple light receiving circuits.

### CROSS-REFERENCE TO RELATED APPLICATION

This application claims priority under 35 U.S.C. § 119 to Japanese Patent Application No. 2021-56543, filed Mar. 30, 2021, the contents of which are incorporated herein by reference in their entirety.

### BACKGROUND

### 1. Field of the Invention

The present disclosure relates to a ranging device and a method for determining a distance.

### 2. Description of the Related Art

Conventional ranging devices are known in which light emitted by a light emitting unit is delivered to an emission area and then a distance to an object is measured based on returned light from the object within the emission area.

A system is disclosed in which multiple beams, into which light output from a light source is separated, are delivered to the emission area, and then distance information about the object is determined based on returned beams that are obtained by the multiple beams reaching the object within the emission area and are transmitted from respective locations (see, for example, Patent Document 1).

### CITATION LIST

### Patent Document

Patent Document 1: Japanese Patent No. 6489320

### SUMMARY

In the ranging device, a time period in which the light emitting unit can emit light per unit of time may be limited in consideration of a lifetime of the light emitting unit, requirements for an eye-safe manner, or the like. For this reason, light beams cannot be delivered to a wider emission area so as to be closely spaced apart from one another. In the configuration described in Patent Document 1, the emission area, as well as intervals between beams, may be determined based on the number of beams into which the light from the light source is separated, and consequently a wider ranging area cannot be used to perform ranging with a high spatial resolution.

A ranging device according to one aspect of the present disclosure includes a light emitting circuit configured to emit light and a splitter configured to split the light into multiple beams. The ranging device includes a scanning circuit configured to perform scanning in two axial directions while aiming the multiple beams toward an emission area. The ranging device includes multiple light receiving circuits configured to respectively receive beams obtained from the multiple beams that are reflected or scattered by an object present in the emission area, the light receiving circuits being configured to respectively output light reception signals. The ranging device includes a distance-information outputting circuit configured to output distance information about the object, the distance information being obtained based on each of the light reception signals that is output from a corresponding light receiving circuit among the multiple light receiving circuits.

### BRIEF DESCRIPTION OF THE DRAWINGS

FIG. 1 is a diagram illustrating a typical ranging device that irradiates an emission area with light;

FIG. 2 is a perspective view of an example of the whole configuration of a ranging device according to one embodiment;

FIG. 3 is a partially enlarged perspective view of an example of a peripheral configuration of an LD and an APD according to one embodiment;

FIG. 4 is a partially enlarged perspective view of an example of the configuration of a light scanner according to one embodiment;

FIGS. 5A to 5C are diagrams for describing separation of light by a grating 41 according to one embodiment;

FIG. 6 is a block diagram illustrating the overall configuration of the ranging device according to one embodiment;

FIG. 7 is a block diagram illustrating an example of the configuration of a controller of the ranging device according to one embodiment;

FIG. 8 is a block diagram illustrating an example of the configuration of a TDC according to one embodiment;

FIG. 9 is a timing chart illustrating an example of measuring a time length by a clock counter according to one embodiment; and

FIG. 10 is a diagram illustrating an example of the configuration of a TDL.

### DESCRIPTION OF THE EMBODIMENTS

One or more embodiments of the present disclosure will be described below with reference to the drawings. In each drawing, the same numerals denote the same components, and description for the components will be omitted as needed.

One or more embodiments are described using an example of a ranging device, and are not limiting. The dimensions, materials, shapes, relative arrangement, and the like of components described below are not limiting and are intended to be examples unless otherwise specified. The sizes of components and the positional relationship among components illustrated in the figures may be exaggerated for purposes of facilitating understanding of the foregoing description.

In each figure, directions may be expressed by an X-axis, a Y-axis, and a Z-axis, respectively. An X-direction referring to the X-axis is referred to as a first axial direction that is a rotation axis of a polygon mirror provided in the ranging device according to one or more embodiments. A Z-direction referring to the Z-axis is referred to as a second axial direction that is a rotation axis of a rotary stage provided in the ranging device according to one or more embodiments. The X-axis and the Z-axis are perpendicular to each other. A Y-direction referring to the Y-axis is a direction perpendicular to both the X-axis and the Z-axis.

A direction expressed by an arrow, in the X-direction, is referred to as a positive X-direction, and a direction opposite the positive X-direction is expressed as a negative X-direction. A direction expressed by an arrow, in the Y-direction is referred to as the positive Y-direction, and a direction opposite a positive Y-direction is referred to as a negative Y-direction. A direction expressed by an arrow, in the Z-direction, is referred to as a positive Z-direction, and a direction opposite the positive Z-direction is referred to as a negative Z-direction. The ranging device emits light in the positive Y-direction. However, orientation of the ranging device is not limiting during use of the ranging device, and the ranging device can be disposed in any orientation.

The ranging device according to one or more embodiments includes a light emitting unit, and a light separating unit that splits light emitted by the light emitting unit into multiple beams. The ranging device also includes a light scanner that performs scanning in two axial directions, while aiming the multiple beams toward an emission area. The ranging device further includes a plurality of light receiving units that receive beams, obtained from the multiple beams aimed by the light scanner, that are reflected or scattered by an object existing in the emission area, the plurality of light receiving units outputting light reception signals, respectively. The ranging device includes a distance-information outputting unit that outputs distance information about the object, the distance information being obtained based on each of pieces of light reception signals that are output from a corresponding light receiving unit among the plurality of light receiving units.

Such a ranging device includes a light detection and ranging (lidar) device or the like that can determine distance information about an object that exists around the device. The distance information about the object includes one or more among (i) information indicating a distance from a given ranging device to the object, (ii) information indicating the presence or absence of the object, and (iii) the like.

The emission area is an area to which the ranging device directs light in a scan. The ranging device delivers the light to the emission area in order to perform scanning in two axial directions that are substantially perpendicular to each other. With this arrangement, the object existing in the emission area can be irradiated with the light.

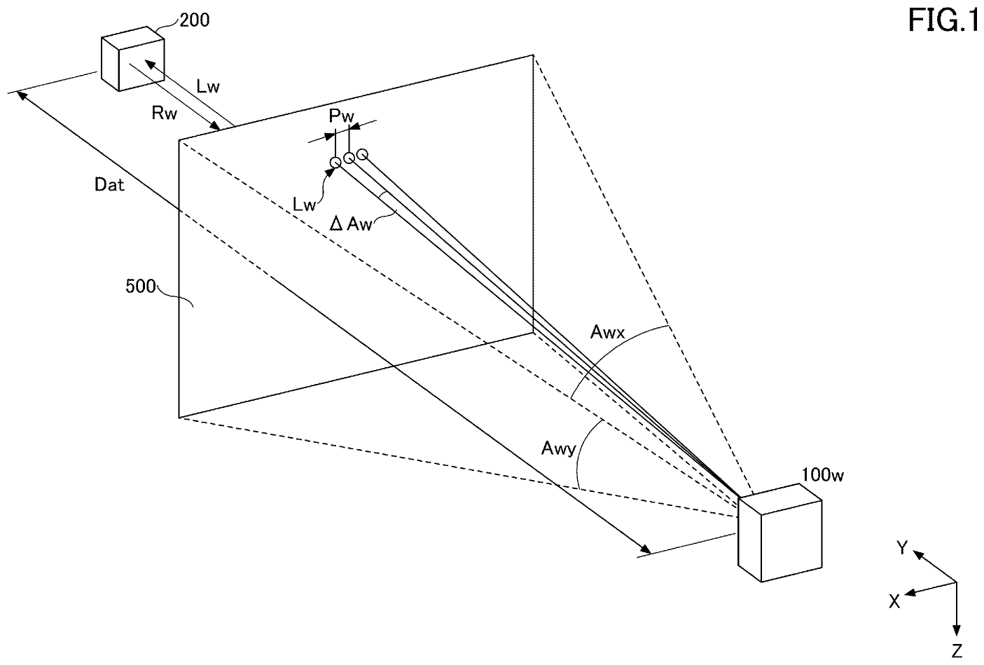

FIG. 1 is a diagram illustrating a typical ranging device 100w that irradiates an emission area 500 with light. As illustrated in FIG. 1, the ranging device 100w aims emission beams Lw towards the emission area 500 in two axial directions that are the X-direction and the Y-direction, in order to perform scanning. The ranging device 100w obtains distance information Dat about an object 200, based on each return beam Rw that is obtained from a corresponding emission beam Lw that is reflected or scattered by the object 200 existing in the emission area 500.

In FIG. 1, an angle range Awx is a range of angles at which the ranging device 100w emits a beam in an X-direction scan. An angular range Awy is a range of angles at which the ranging device 100w emits a beam in a Y-direction scan. An angle interval Pw is an interval between angles at which emission beams LW are emitted in the scan. The angle interval Pw is determined based on an emission time period per unit of time, a scan speed, and the like.

The emission area 500 determined based on the angular ranges Awx and Awy corresponds to a ranging area where the ranging device 100w can determine distances. The angle interval Pw depends on a spatial resolution of the ranging device 100w. A position of the emission area 500w in the Y-direction is not limited to the example illustrated in FIG. 1, and any position may be used.

When a light emitting unit such as a semiconductor laser is used in the ranging device, a per unit (e.g., one second) time period during which the light emitting unit emits light may be limited because there is need or the like for lifetime of the light emitting unit or for eye safety. The eye safety means that even when light emitted by the light emitting unit enters a person's eye, it does not damage the person's eye.

When the time period during which the light emitting unit emits the light is limited, a greater angle interval Pw at which the ranging device 100w irradiates the emission area 500 with the emission beams Lw may be obtained. Also, when the emission beams Lw are emitted such that the angle interval Pw is reduced, an extent of the emission area 500 may be reduced. Therefore, in order to make improvements, a wider ranging area is used to perform ranging with a high spatial resolution.

In one or more embodiment, light generated by the light emitting unit is separated into a plurality of beams, and the beams are aimed toward the emission area in two axial directions, in order to perform scanning in two axial directions. Thus, a smaller angle interval at which the ranging device aims the emission beams toward the emission area is obtained. For example, when light that the light emitting unit emits is separated into five beams to travel in predetermined directions, the beams can be aimed toward a predetermined extent of the emission area in the predetermined directions, so as to be at angle intervals each of which is at one-fifth an angle interval obtained in a case where the light is not separated. With this arrangement, a spatial resolution corresponding to such angular intervals is obtained, and thus a wider ranging area can be used to perform ranging with a high spatial resolution.

One or more embodiments are described below using an example of the ranging device that can obtain distance information about an object in time-of-flight (TOF), and the object is provided on a service robot and exists in a traveling direction or surrounding area of the service robot.

The service robot is an autonomous mobile body that is mainly used in order to achieve its intended service, e.g., to transport materials in a factory, transport goods and provide a guide at a customer service facility, guard a facility, provide cleaning, or the like. The moving body is a movable object.

The ranging device provided in such a service robot is used to detect an object that exists in a traveling direction or around the service robot, to create a map or the like about a facility in which the service robot operates.

<Example of Configuration of Ranging Device 100>

### (Whole Configuration)

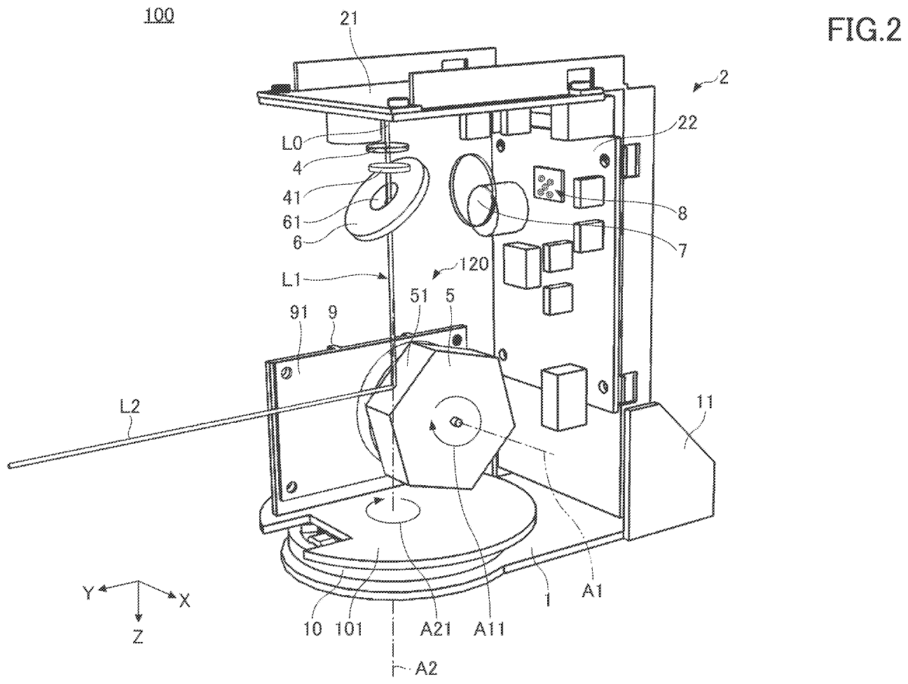

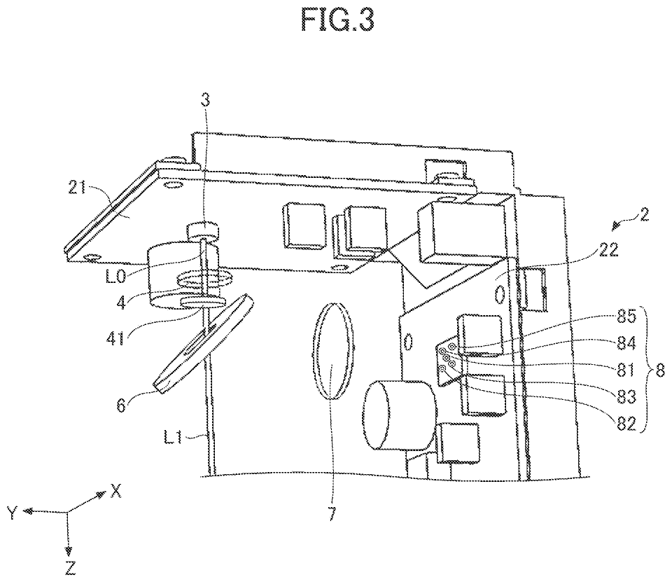

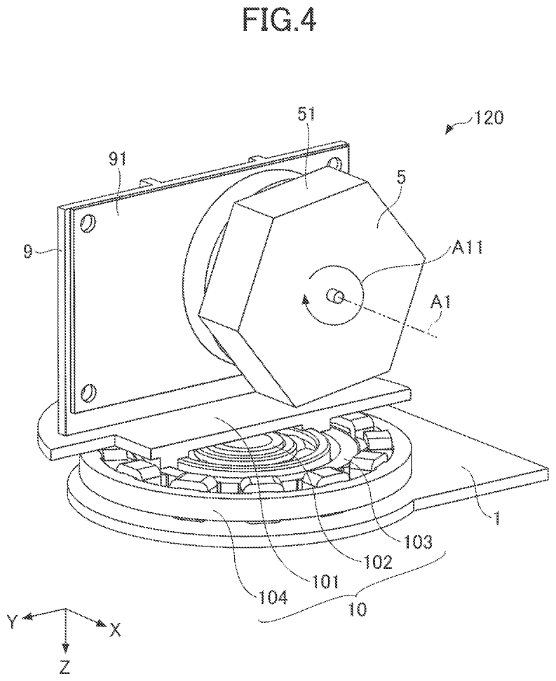

An example of the whole configuration of a ranging device 100 according to one embodiment will be described with reference to FIGS. 2 to 4. FIG. 2 is a perspective view of an example of the whole configuration of the ranging device 100. FIG. 3 is an enlarged perspective view of an example of the configuration around an LD and APDs. FIG. 4 is an enlarged perspective view of an example of the configuration of a light scanner 120.

As illustrated in FIGS. 2 to 4, the ranging device 100 includes a base plate 1, a holder 2, a laser diode (LD) 3, a collimating lens 4, and a polygon mirror 5. The ranging device 100 also includes a mirror 6 having openings, an optical receiving lens 7, avalanche photodiodes (APDs) 8, a square 9, and a rotary stage 10.

The base plate 1 is a base on which the holder 2 and the rotary stage 10 are provided. However, the base is not limited to a flat plate-like member such as the base plate 1. When the rotary stage 10 and the holder 2 are provided, any component may be adopted as the base plate. For example, when the holder and the rotary stage are provided on a housing of a service robot, the housing of the service robot may be the base.

The base plate 1 is a flat plate-like member, and the holder 2 and the rotary stage 10 are fixed to a surface opposite a surface of a flat plate in the negative Z-direction. The rotary stage 10 is fixed to a surface of the base plate 1 in the positive Y-direction, with one or more screws or the like. The holder 2 is fixed, through a coupling member 11, to the surface of the rotary stage 10 in the negative Y-direction, with one or more screws or the like.

Although the material of the base plate 1 is not particularly limited, it is preferable to form the base plate 1 including a rigid material such as a metal material, because the rotary stage 10 may be heavy.

The holder 2 is an inverted L-shaped member that is formed by a combination of a ceiling panel 21 and a back panel 22. Each of the ceiling panel 21 and the back panel 22 is a flat plate-like member. The holder 2 is formed by coupling the ceiling panel 21 with the back panel 22. Although the material of each of the ceiling panel 21 and the back panel 22 is not particularly limited, a metallic material or resinous material can be applied, for example.

The LD 3, the collimating lens 4, and the mirror 6 are provided on a surface of the ceiling panel 21 in the positive Z-direction. The optical receiving lens 7 and the APDs 8 are provided on a surface of the back panel 22 in the positive Y-direction. The holder 2 holds the LD 3 at the ceiling panel 21 and holds the APDs 8 at the back panel 22.

The LD 3 is an example of a light emitting unit that emits light. The LD 3 emits laser light L0, as pulsed light, in the positive Z-axis direction. However, the light emitting unit is not limited to the LD, and a light emitting diode (LED) or the like may be used.

Although the wavelength of the laser light L0 is not particularly limited, laser light having a non-visible wavelength range, such as a near infrared wavelength range, is used more preferably because it enables ranging without being visible to a person.

The collimating lens 4 includes a glass material or a resinous material, and approximately collimates the laser light L0. The collimating lens 4 is not necessarily provided. However, when the collimating lens 4 is provided, spreading of the laser light L0 is suppressed and thus efficiency in using light is improved.

The laser light L0 collimated by the collimating lens 4 enters a grating 41 and is separated into five beams L1 by the grating 41. The grating 41 is an example of a splitter that splits the laser light L0 into a plurality of (e.g., five) beams L1.

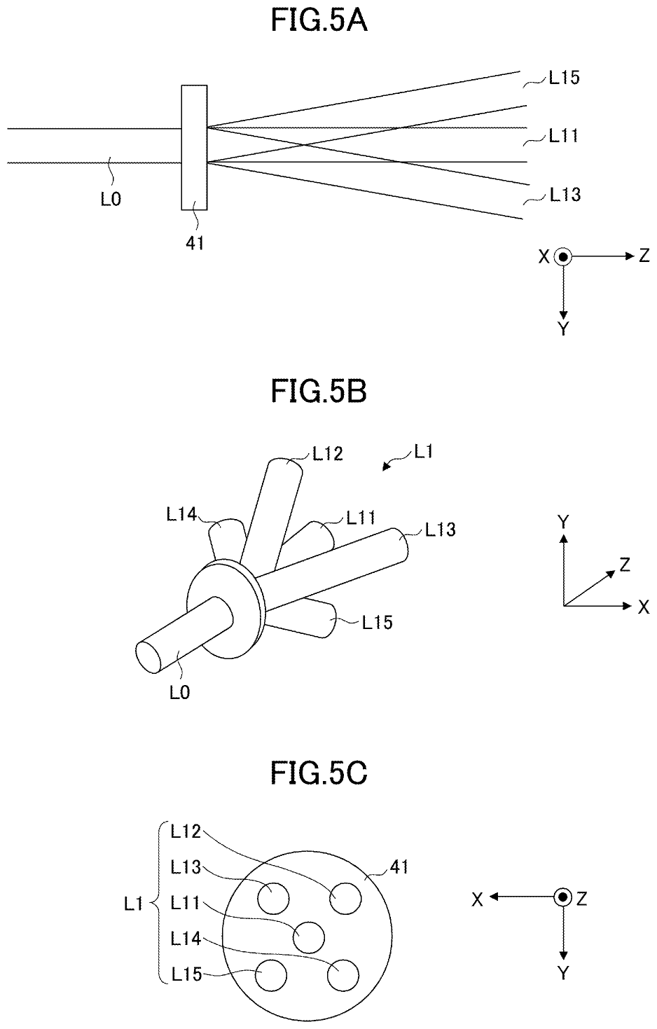

The beams L1 pass through a through-hole 61 provided in the mirror 6 and enter a given reflective surface 51 of the polygon mirror 5. An action of the grating 41 and the beams L1 will be described below in detail with reference to FIG. 5.

The polygon mirror 5 is a rotary polyhedron having a plurality of reflective surfaces 51. The polyhedron reflects the laser light L1 from a given reflective surface 51, while rotating about a first axis A1, and thus emits scan laser beams L2 corresponding to reflected beams that are obtained from the laser light L1, in order to perform scanning. The scan beams L2 are emitted based on rotation of the mirror about the first axis A1. The plurality of reflective surfaces are collectively referred to as the reflective surfaces 51.

The polygon mirror 5 rotates so as to track a portion of a circle of which the center is the first axis A1, and thus causes reflected beams from the reflective surface 51 to be emitted in the scan. In other words, the beams emitted through the rotation of the mirror about the first axis A1 are each emitted in a circumferential direction of the circle of which the center is the first axis A1.

The polygon mirror 5 is a regular hexagonal prism-like member. Six reflective surfaces 51 are respectively formed on the outer peripheral surfaces each of which corresponds to a side of a regular hexagonal shape in the regular hexagonal prism. The polygon mirror 5 can be manufactured by cutting or mirror-polishing an outer peripheral surface of a generally regular hexagonal prism-like member that is formed of a metallic material such as aluminum. However, the polygon mirror 5 is not limited to this example. For example, the polygon mirror 5 may be fabricated by evaporating a mirror surface with aluminum or the like, on the outer peripheral surface of a substantially hexagonal prism-like member that is formed of a metallic material, a resin material, or the like.

In FIG. 2, the polygon mirror 5 having a regular hexagonal prism with six reflective surfaces 51 is used as an example, but a rotary polygon is not limited thereto. For example, a rotary polyhedron having a regularly triangular prism with three reflective surfaces may be used, or a rotary polyhedron having a regular pentagonal prism with five reflective surfaces may be used.

Depending on the number of surfaces of a given rotary polyhedron, a scan range of angles at which the rotary polyhedron emits a beam varies. For example, as the number of polyhedron surfaces is increased, a narrower scan range of angles is obtained. In contrast, as the number of polyhedron surfaces is reduced, a wider scan range of angles is obtained. The number of surfaces of a given rotary polyhedron can be appropriately determined based on a required scan range of angles.

A first axis motor is attached to the polygon mirror 5 such that a central axis and rotation axis of the polygon mirror 5 substantially coincide with each other. The polygon mirror 5 rotates about the first axis A1 while using the first axis motor as a drive source.

A rotation direction of the polygon mirror 5 is fixed, and the polygon mirror 5 rotates continuously so as to move in a first axis rotation direction A11, for example, as illustrated in FIG. 2. However, the polygon mirror 5 may continuously rotate so as to move in a fixed rotation direction that is opposite the first axis rotation direction A11.

The laser beams L1 entering a given reflective surface 51 of the polygon mirror 5 are reflected from the given reflective surface 51 and are transmitted in the positive Y-direction. When an angle of the given reflective surface 51, relative to an incident direction of each laser beam L1, continuously varies in accordance with rotation of the polygon mirror 5, a reflected beam from the given reflective surface 51 is emitted in the scan, through the rotation of the mirror about the first axis A1, and then is aimed in the positive Y-direction as a scan laser beam L2. FIG. 2 illustrates the scan laser beam L2, as one laser beam, directed in the positive Y-direction at any timing, the scan laser beam L2 being among scan laser beams L2 that are emitted through the rotation of the mirror 5 about the first axis A1.

When an object is present in the positive Y-direction of the ranging device 100, returned beams obtained from the scan laser beams L2 that are reflected or scattered by the object are returned to the ranging device 100. The returned beams again enter a given reflective surface 51 of the polygon mirror 5, based on the rotation of the polygon mirror 5 about the first axis A1. Among the returned beams to be used in the scan, returned beams reaching the mirror 6 are reflected in the negative Y-direction by the mirror 6.

In the present embodiment, a given reflective surface 51 of the polygon mirror 5 from which the laser beams L1 are reflected, as well as a given reflective surface 51 of the polygon mirror 5 from which the returned beams are reflected, are the same reflective surfaces. Returned beams obtained by reflection from the same reflective surface of the polygon mirror 5 are received at the APDs 8, respectively.

In other words, after the scan laser beams L2 reflected from a predetermined surface, among reflective surfaces 51 included in the polygon mirror 5, are reflected or scattered by the object, the APDs 8 receive respective returned beams that are obtained by performing reflection from the predetermined surface again.

The mirror 6 is an optical deflector that deflects returned beams obtained from the scan laser beams L2 that are reflected or scattered by the object. The mirror 6 includes a through-hole 61. The through-hole 61 is an opening through which light emitted from the LD 3 passes, and is formed in a portion of a reflective surface of the mirror 6. Among beams to enter the mirror 6, given beams are reflected from the reflective surface of the mirror 6, and given beams pass through the through-hole 61.

The present embodiment is described using an example of the configuration of the optical deflector having the through-hole as an opening, but the optical deflector is not limited to this example. A portion of the reflective surface of the optical deflector is formed transparently, and the transparent surface portion may function as an opening through which the beam passes. A beam splitter, a half mirror, or the like can be also used as the optical deflector.

The mirror 6 causes the laser beams L1 collimated by the collimating lens 4 to pass through the through-hole 61. The mirror 6 can also cause returned beams, which are obtained by reflecting or scattering the scan laser beams L2 by the object, to be reflected from the reflective surface of the mirror 6, so as to be directed toward the APDs 8.

Beams reflected by the mirror 6 enter the respective APDs 8, while being collected by the optical receiving lens 7. The optical receiving lens 7 may not necessarily be provided. However, when the optical receiving lens 7 is provided, it is suitable for improving efficiency in aiming laser beams at the APDs 8.

The APDs 8 include five APDs 81 to 85 and are examples of a plurality of light receiving units each of which outputs a light reception signal based on the beam reflected or scattered by the object. The APDs 81 to 85 are collectively referred to as the APDs 8. Each APD 8 is a photodiode having photosensitivity improved using a phenomenon called avalanche multiplication. However, the light receiving unit is not limited to the APD, and a photodiode (PD) other than the APD, a photomultiplier tube, or the like may be used. A different light receiving unit, such as an APD or a PD, may be adopted for each of the light receiving units.

The square 9 is an L-shaped member and is a support that supports the polygon mirror 5. The bottom surface (surface in the negative Z-direction) of the square 9 contacts a mounting surface 101 of the rotary stage 10, and the square 9 is fixed to the mounting surface 101 with one or more screws, or the like. The square 9 fixes the polygon mirror 5 at a front surface (surface in the positive X-direction) that meets the bottom surface of the square, through a substrate 91. Although the material of the square 9 is not particularly limited, the square 9 preferably includes a highly rigid material, such as a metal, in order to ensure increased stiffness.

The rotary stage 10 is a rotary mechanism that rotates the square 9 about a second axis A2 to thereby cause the scan laser beams L2 reflected from the reflective surface 51 of the polygon mirror 5, which is fixed to the square 9, to be emitted in a scan based on the rotation of the rotary stage about the second axis A2.

The rotary stage 10 is provided in a region of the base plate 1 different from a region of the base plate 1 in which the holder 2 is provided. With this arrangement, even if the rotary stage 10 rotates, the holder 2, as well as the LD 3 and APDs 8 that are held by the holder 2, do not move, and are maintained in a fixed state to the base plate 1.

The rotary stage 10 rotates so as to track a portion of a circle of which the center is the second axis A2, and thus causes reflected beams from a given reflective surface 51 of the polygon mirror 5 to be emitted in the scan. In other words, the beams obtained based on the rotation of the rotary stage about the second axis A2 are each emitted in a circumferential direction of the circle of which the center is the second axis A2.

As illustrated in FIG. 4, the rotary stage 10 includes the mounting surface 101, a bearing 102, a magnet 103, and a motor core 104.

The mounting surface 101 is a rotatable surface about the second axis A2 (see FIG. 2). The square 9 is mounted on the mounting surface 101. The bearing 102 is a member that smooths the rotation of the mounting surface 101. A ball bearing, a cross roller bearing, or the like can be applied to the bearing 102.

The magnet 103 may be composed of a permanent magnet. The motor core 104 is a member corresponding to an iron core of a stator that constitutes part of a motor. The motor includes the magnet 103 and the motor core 104. The magnet 103 rotates in accordance with a current, and the mounting surface 101 is rotated through the bearing 102.

The rotation direction of the rotary stage 10 is fixed. For example, the rotary stage 10 continuously rotates so as to move in a second axis rotation direction A21 in FIG. 2. However, the rotary stage 10 may continuously rotate so as to move in a fixed rotation direction that is opposite the second axis rotation direction A21.

As illustrated in FIG. 2, the position and inclination angle for each of the LD 3, the collimating lens 4, and the rotary stage 10 are adjusted such that the laser light L0, which is emitted by the LD 3 and is collimated by the collimating lens 4, enters a given reflective surface 51 of the polygon mirror 5 so as to be directed in the second axis A2.

For example, the ranging device 100 is configured such that an optical axis of the laser light L0 and the second axis A2 are coaxial. The optical axis of the laser light L0 means an axis that passes through the center of a laser beam. The term “coaxial” means that multiple axes are approximately identical.

The scan laser beams L2 are emitted in the scan in which the polygon mirror 5 rotates about the first axis A1, while being emitted in the scan in which the rotary stage 10 rotates about the second axis A2. The ranging device 100 can emit the laser beam in order to perform scanning in two axial directions that are perpendicular to each other. The polygon mirror 5 and the rotary stage 10 constitute the light scanner 120 that performs scanning by directing multiple beams L1 into which the grating 41 separates the laser light L0 to the emission area in the two axial directions that are the X-axis direction and Z-axis direction.

In the present embodiment, the first axis A1 and the second axis A2 are substantially perpendicular to each other. However, such a manner is not limiting, and the second axis A2 may be inclined with respect to the first axis A1.

In FIGS. 2 to 4, the ranging device 100 does not include an outer cover, but may include the outer cover that covers a portion or all of components that include the LD 3, the polygon mirror 5, the APDs 8, the rotary stage 10, and the like.

When the outer cover is provided in the ranging device 100, dust or the like is prevented from entering the inside of the ranging device 100, and thus the dust or the like can be prevented from adhering to the polygon mirror 5 or the like. When the polygon mirror 5 or the rotary stage 10 rotates at high speed, wind noises caused by the rotation of the polygon mirror or rotary stage may be increased. However, when the outer cover is provided, the noises can be prevented from being transmitted to the surrounding area. As the material of the outer cover, a metal or resin material can be applied.

In contrast, when the outer cover is provided, a scan angle range is limited, and thus a detection range in which the ranging device 100 detects the object 200, or a ranging range in which the ranging device 100 performs ranging may be limited, because a portion of the outer cover, other than an exit window from which the scan laser beams L2 exits, blocks the scan laser beams L2. When the outer cover is formed of a transparent resin material having an optical transparency to wavelengths of the scan laser beams L2, limitations to the scan angle range described above can be mitigated advantageously.

Hereafter, separation of light by the grating 41 will be described with reference to FIG. 5. FIGS. 5A to 5C are diagrams for describing an example of the separation of the light by the grating 41. FIG. 5A is a side view of the grating 41. FIG. 5B is a perspective view of the grating 41 when viewed in the negative Z-direction. FIG. 5C is a front view of the grating 41 when viewed in the positive Z-direction.

As illustrated in FIGS. 5A to 5C, the grating 41 has a substantially circular shape in a plan view and is a transparent plate-like member having an optical transparency to the laser light L0. Periodic structures are formed on at least one among the front surface (surface in the negative Z-direction) and the back surface (surface in the positive Z-direction) of the grating 41. The grating 41 splits incoming laser light L0 into multiple beams, by diffracting the laser light L0 in directions determined based on the arranged periodic structures.

In the present embodiment, the grating 41 splits the laser light L0 into five beams L11 to L15. The beams L11 to L15 are collectively referred to as beams L1. A beam L11 is light having 0th order (transmitted light) transmitted by the grating 41, and each of beams L12 to L15 is light having a first order diffracted by a corresponding periodic structure that is arranged so as to enable the beam to be directed in a corresponding propagation direction.

The beams L11 to L15 are beams parallel to one another so as to be directed in different directions, respectively. The beams L11 to L15 pass through the mirror 6, and are emitted in the X-direction and the Y-direction, by the light scanner 120. Scan laser beams L21 to L25 corresponding to the respective beams L11 to L15 are each aimed at a different location in the emission area 500.

In the present embodiment, the grating 41 having a substantially circular shape in a plan view is illustrated, but is not limited to having such a shape. The grating may have a rectangular shape or an elliptical shape. Also, the laser light L0 is separated into five beams, but the number of beams into which the light is separated is not limiting as long as multiple beams are used. The laser light L0 can be appropriately selected based on a required spatial resolution or the like. Further, the beam L11, which is transmitted through the center of the front surface of the grating 41, is combined with beams L12 to L15 into which the light is separated and that travel in respective four diagonal directions. However, directions in which beams into which light is separated are directed are not limited to this example, and can be appropriately selected depending on the application.

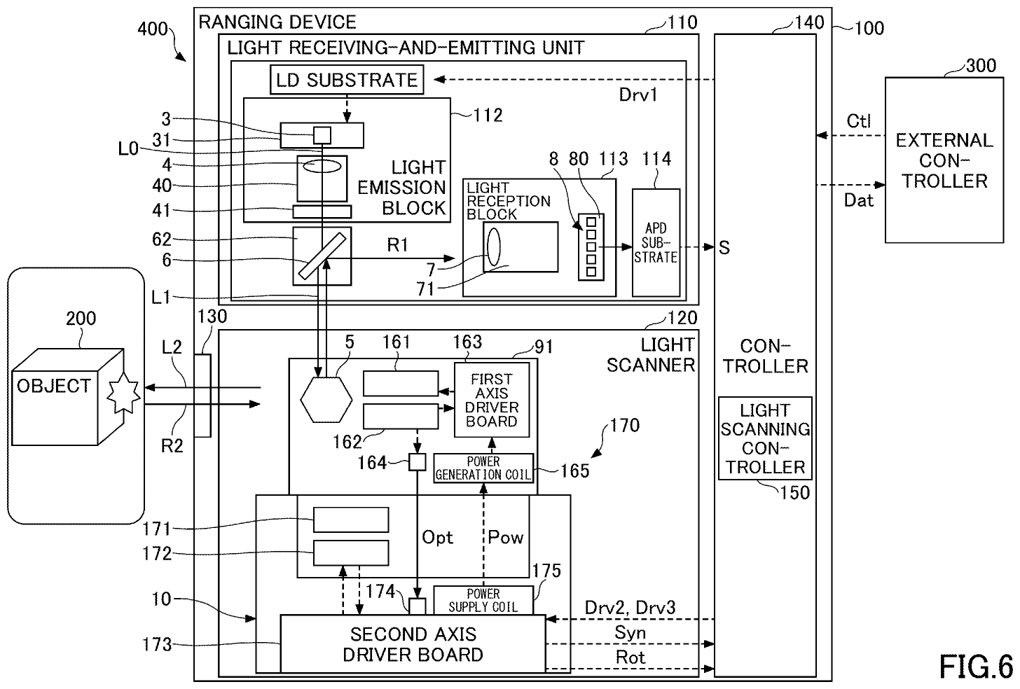

FIG. 6 is a block diagram illustrating an example of the whole configuration of the ranging device 100. The description for the configuration that has been described with reference to FIGS. 2 to 5 will be omitted as needed. Solid arrows in FIG. 6 express optical flows, and dashed arrows express flows of electrical signals.

As illustrated in FIG. 6, the ranging device 100 includes a light emitting-and-receiving unit 110, the light scanner 120, an exit window 130, and the controller 140.

The controller 140 is electrically coupled to each of the external controller 300, the light emitting-and-receiving unit 110, and the light scanner 120. The controller 140 can transmit signals and data to one or more components, as well as receiving signals and data from one or more components. The controller 140 includes the light scanning controller 150 that controls the light scanner 120.

The controller 140 includes a control circuit board that includes an electrical circuit or an electronic circuit, and is provided on, for example, the back panel 22 (see FIG. 2). With this arrangement, even when the polygon mirror 5 and the rotary stage 10 rotate, the control circuit board constituting the controller 140 does not move.

The external controller 300 is a controller that controls a service robot, and includes a board personal computer (PC) or the like in which a robot operating system is provided.

The light emitting-and-receiving unit 110 includes an LD substrate 111, a light emission block 112, and the mirror 6. The light emitting-and-receiving unit 110 also includes a mirror holder 62, a light reception block 113, and an APD substrate 114.

The LD substrate 111 includes an electrical circuit that causes the LD 3 to emit light in response to an emission control signal Drv1 from the controller 140.

The light emission block 112 includes the LD 3, a LD holder 31, the collimating lens 4, and a collimating lens holder 40. The LD holder 31 is a member that holds the LD 3. The collimating lens holder 40 is a member that holds the collimating lens 4. The mirror holder 62 is a member that holds the mirror 6.

The light reception block 113 includes a light receiving lens 7, a light receiving lens holder 71, APDs 8, and an APD holder 80. The light receiving lens holder 71 is a member that holds the light receiving lens 7. The APD holder 80 is a member that holds the APDs 8.

The APD substrate 114 includes an electrical circuit that outputs light reception signals S, each of which is an electrical signal corresponding to intensity of a beam that the APD 8 receives, to the controller 140.

The light scanner 120 includes a substrate 91 and the rotary stage 10. The polygon mirror 5, a first axis motor 161, a first axis encoder 162, a first axis driver board 163, a synchronization-detecting LED 164, and a power generation coil 165 are provided on the substrate 91. A second axis motor 171, a second axis encoder 172, a second axis driver board 173, a synchronization-detecting PD 174, and a power supply coil 175 are provided on the rotary stage 10.

A pair of the power generation coil 165 and the power supply coil 175 constitutes a power supply 170. The power supply 170 can supply power through electromagnetic induction, without contacting the first axis motor 161 and the like.

The first axis motor 161 is a rotation driver that rotates the polygon mirror 5. A direct current (DC) motor, an alternating current (AC) motor, or the like may be applied to the first axis motor 161.

The first axis encoder 162 is a rotary encoder, and is a detector that detects a rotation angle of the polygon mirror 5.

The first axis driver board 163 is a board that includes an electrical circuit or the like that supplies a drive signal to the first axis motor 161. The first axis driver board 163 can control the polygon mirror 5 based on a detection signal from the first axis encoder 162, to thereby rotate at a predetermined rotation rate.

Although the first axis driver board 163 is used to adjust the rotation rate of the polygon mirror 5, the light scanning controller 150 does not control the rotation rate. In other words, the rotation rate of the polygon mirror 5 is not a target that the light scanning controller 150 controls. In this case, starting and stopping of the rotation of the polygon mirror 5 are performed based on a polygon control signal Drv2 from the light scanning controller 150. The control of the rotation rate can also be referred to as a control of a rotational speed.

The synchronization-detecting LED 164 is a synchronization output unit that outputs an optical signal Opt that is synchronized with rotation of the polygon mirror 5, based on the rotation angle of the polygon mirror 5.

Specifically, the synchronization-detecting LED 164 emits pulsed light based on a detection signal that indicates a given rotation angle of the polygon mirror 5 and is output from the first axis encoder 162. The pulsed light emitted by the synchronization-detecting LED 164 corresponds to the optical signal Opt that is synchronized with the rotation of the polygon mirror 5, and the synchronization-detecting LED 164 can output the optical signal Opt by emitting the pulsed light.

The power generation coil 165 is a coil that generates a back electromotive force by electromagnetic induction, and supplies power to each of the first axis motor 161, the first axis encoder 162, and the first axis driver board 163.

The second axis motor 171 is a motor that rotates the rotary stage 10. Any one motor among a DC motor, an AC motor, a stepping motor, and the like can be applied to the second axis motor 171. The second axis encoder 172 is a rotary encoder that detects a given rotation angle of the rotary stage 10.

The second axis driver board 173 is a board that includes an electrical circuit or the like that supplies a drive signal to the second axis motor 171. The second axis driver board 173 rotates the rotary stage 10 based on a stage control signal Drv3 from the light scanning controller 150.

The second axis driver board 173 transmits a feedback indicating a given rotation angle of the rotary stage 10 that is detected by the second axis encoder 172, to the light scanning controller 150 as a second axis rotation-angle signal Rot. The light scanning controller 150 can control the rotary stage 10 based on the second axis rotation-angle signal Rot.

The rotation rate of the rotary stage 10 is adjusted by the light scanning controller 150, and is a target that the light scanning controller 150 controls.

The synchronization-detecting PD 174 outputs, to the second axis driver board 173, a signal obtained by receiving the pulsed light that the synchronization-detecting LED 164 emits. For example, the synchronization-detecting LED 164 emits pulsed light at a timing at which the first axis encoder 162 detects an angle corresponding to the rotation origin of the polygon mirror 5.

The synchronization-detecting PD 174 receives the pulsed light that the synchronization-detecting LED 164 emits, to thereby detect a synchronization timing at which the polygon mirror 5 rotates. The second axis driver board 173 is used to output, to the controller 140, a synchronization signal Syn indicating the synchronization timing at which the polygon mirror 5 rotates, and the synchronization signal Syn is output based on an input signal from the synchronization-detecting PD 174.

The power supply coil 175 is a coil disposed facing the power generation coil 165. When the current flows from the second axis driver board 173, the coil causes a back electromotive force to be generated on the power generation coil 165 through electromagnetic induction.

For example, when the current flows through the power supply coil 175, the resulting electromagnetic induction causes a back electromotive force to be generated through the power generation coil 165 in a non-contact manner. The power generation coil 165 is used to cause power Pow to each of the first axis motor 161, first axis encoder 162, and first axis driver board 163, through the generated back electromotive force.

In the present embodiment, the power supply 170 supplies power in a non-contact manner, through electromagnetic induction, but is not limited to this example. For example, the power supply 170 can be powered by a rotary contact. The rotary contact is configured so as to be electrically coupled to a rotating body via a metal ring and brush that are disposed in the rotating body. With use of such a rotary contact, power from an external device can be supplied to the first axis motor 161 or the like.

As illustrated in FIG. 6, the controller 140 outputs the emission control signal Drv1 in response to a ranging control signal Ctl from the external controller 300, and then causes the LD 3 to emit laser light through the LD substrate 111. The laser light L0 that is emitted by the LD 3 and is collimated by the collimating lens 4 is separated into five beams L1 by the grating 41. The beams L1 pass through the mirror 6 and enter a given reflective surface 51 of the polygon mirror 5. Then, after the beams L1 are reflected from the given reflective surface 51, the beams L1 pass through the exit window 130, and are directed, as scan laser beams L2, from the ranging device 100 to the outside, respectively.

The exit window 130 includes a glass material or resinous material, which has an optical transparency to the wavelength of the laser light L0. When the ranging device 100 includes an opaque outer cover that covers the whole device, the exit window 130 is a member that functions as a window through which the scan laser beams L2 pass and from which the scan laser beams L2 are exited.

The returned beams R2 obtained from the scan laser beams L2 that are reflected or scattered by the object 200 pass through the exit window 130, and enter a given reflective surface 51 of the polygon mirror 5. Then, the resulting beams that are reflected from the given reflective surface 51 are reflected by the mirror 6, as returned beams R1 to be directed toward the APDs 8, respectively.

The returned beams R1 enter the respective APDs 8, while being focused by the light receiving lens 7. Light reception signals S obtained through the respective APDs 8 each of which receives an incoming beam are output to the controller 140 through the APD substrate 114. The controller 140 determines distance information Dat indicating a distance to the object 200, based on each light reception signal, and can output the distance information Dat to the external controller 300.

The scan laser beams L2 include five scan laser beams L21 to L25 that are respectively obtained by emitting five beams L11 to L15 in the scan. The returned beams R2 include the returned beams R21 to R25 that are respectively obtained from the scan laser beams L21 to L25 each of which is directed to the emission area 500. The returned beams R1 include the returned light beams R11 to R15 that are respectively obtained by the returned beams R21 to R25, each of which is reflected by the polygon mirror 5.

The APD 81 receives the returned beam R11 and outputs a light reception signal S1. The APD 82 receives the returned beam R12 and outputs a light reception signal S2. The APD 83 receives the returned beam R13 and outputs a light reception signal S3. The APD 84 receives the returned beam R14 and outputs a light reception signal S4. The APD 85 receives the returned beam R15 and outputs a light reception signal S5.

The APD 81 is arranged at a location at which the returned beam R11 obtained from the beam L11 can be received. Similarly, the APD 82 is arranged a location at which the returned beam R12 obtained from the beam L12 can be received, the APD 83 is arranged at a location at which the returned beam R13 obtained from the beam L13 can be received, the APD 84 is arranged at a location at which the returned beam R14 obtained from the beam L14 can be received, and the APD 85 is arranged at a location at which the returned beam R15 obtained from the beam L15 can be received.

In other words, the scan laser beams L2 from the beams L1 include the scan laser beam L21 (first beam) and the scan laser beam L22 (second beam). The APDs 8 include the APD 81 (first light receiving unit) and the APD 82 (second light receiving unit). The APD 81 outputs the light reception signal S1 based on the returned beam R11 obtained from the scan laser beam L21 that is reflected or scattered by the object 200. The APD 82 outputs the light reception signal S2 based on the returned beam R12 obtained from the scan laser beam L22 that is reflected or scattered by the object 200.

The scan laser beams L21 to L25 are collectively referred to as the scan laser beams L2, the returned beams R21 to R25 are collectively referred to as returned beams R2, and the returned beams R11 to R15 are collectively referred to as returned beams R1.

In FIG. 6, a scanning system 400 provided in the ranging device 100 includes the LD 3, the light scanner 120, the APDs 8, and the light scanning controller 150.

The ranging device 100 can operate with power supplied from a battery that is provided in a given service robot. However, such a manner is not limiting, and power may be supplied to the ranging device 100 from a battery provided in the ranging device 100. Alternatively, when a narrow movement range of the service robot is set, power is supplied to the ranging device 100 from a utility power source, through a cable.

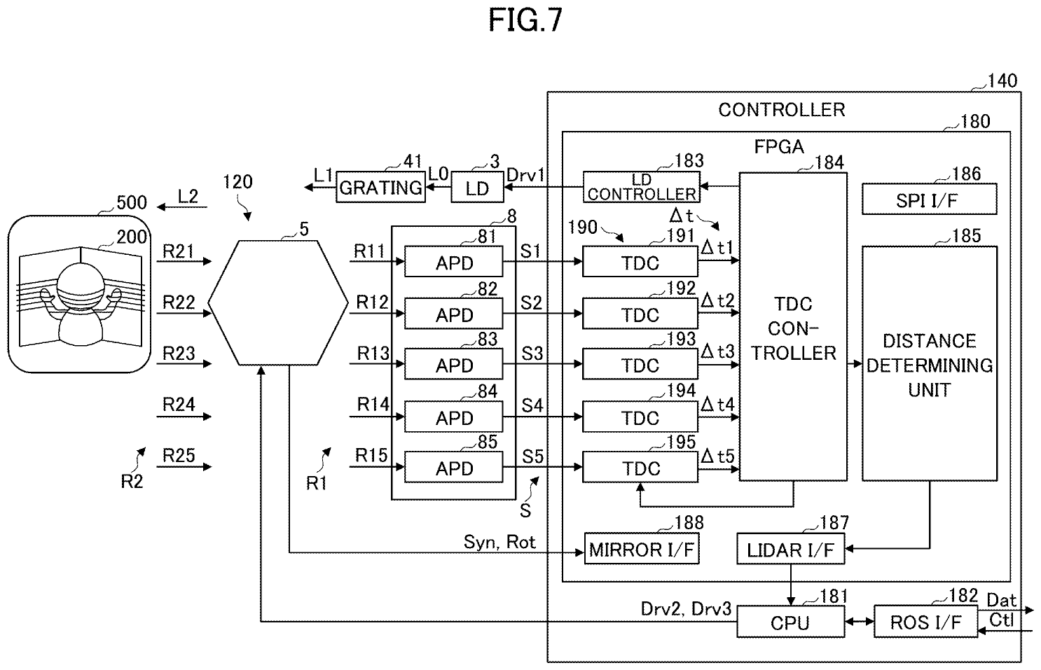

(Hardware configuration of controller 140) FIG. 7 is a block diagram illustrating an example of the hardware configuration of the controller 140 provided in the ranging device 100. As illustrated in FIG. 7, the controller 140 includes a field-programmable gate array (FPGA) 180, a central processing unit (CPU) 181, and a ROS interface (I/F) 182.

As an example of a calculator, the FPGA 180 includes an LD controller 183, a time-to-digital converter (TDC) 190, a TDC controller 184, a distance determining unit 185, a serial peripheral interface (SPI) 186, a lidar I/F 187, and a mirror I/F 188.

The LD controller 183 is a circuit that controls the LD 3. The SPI 186 is a bus that connects circuits in the FPGA 180 to one another.

The TDC controller 184 controls the LD controller 183 and the TDC 190. A time difference between a light emission time ts at which the LD 3 emits the laser light L0 and a light reception time te, at which each returned beam R1 obtained after the laser light L0 is reflected or scattered by the object 200 is received by a given APD 8, is measured and then the measurement result is output to the distance determining unit 185.

Specifically, the TDC controller 184 causes the LD 3 to emit light through the LD controller 183, and causes scan laser beams L2, into which the grating 41 respectively separates the beams L1, to be directed to the emission area 500. The retuned beams R2 obtained from the scan laser beams L2, which are reflected or scattered by the object 200 existing in the emission area 500, are reflected by the polygon mirror 5 and are received by the APDs 8, as returned beams R1, respectively. The APDs 8 output light reception signals S corresponding to the returned beams R1, respectively. The light reception signals S are amplified through a transimpedance amplifier, an operational amplifier, and the like, and are input to the respective TDCs 190.

The TDCs 190 are digital circuits each of which measure a given time difference based on the light reception signal S output from a given APD 8, under the control of the TDC controller 184. The TDCs 190 are examples of a plurality of time difference-information outputting units each of which outputs time difference information Δt between the light emission time ts and the light reception time te. The TDCs 191 to 195 are collectively referred to as the TDCs 190, and each of the TDCs 191 to 195 has the same circuit. However, when the time difference information Δt between the light emission time ts and the light reception time te can be output, each of the TDCs 191 to 195 may have a different circuit.

The TDC 191 outputs time difference information Δt1 obtained based on the light reception signal S1 output from the APD 81, and the TDC 192 outputs time difference information Δt2 obtained based on the light reception signal S2 output from the APD 82. Similarly, the TDC 193 outputs time difference information Δt3 obtained based on the light reception signal S3, the TDC 194 outputs time difference information Δt4 obtained based on the light reception signal S4, and the TDC 195 outputs time difference information Δt5 obtained based on the light reception signal S5.

In other words, the TDCs 190 include the TDC 191 (first time difference-information outputting unit) and the TDC 192 (second time difference-information outputting unit). The TDC 191 outputs the time difference information Δt1 obtained based on the light reception signal S1 output from the APD 81 (first light receiving unit), and the TDC 192 outputs the time difference information Δt2 obtained based on the light reception signal S2 output from the APD 82 (second light receiving unit).

The distance determining unit 185 determines the distance information Dat about the object 200, based on pieces of time difference information Δt1 to Δt5 that are input to the distance determining unit 185 through the TDC controller 184. The distance information Dat is given by Equation (1) below.

Datn={c·Δtn}/2 (1)

In Equation (1), the “n” is used to distinguish among the beams L11 to L15 into which light is separated. For example, when n is 1, a time difference obtained based on the beam L11 is expressed by Δt1, and distance information is expressed by Dat1. When n is 2, a time difference obtained based on the beam L12 is expressed by Δt2, and distance information is expressed by Dat2. Also, c is the speed of light. The unit of distance information Dat is meters, the unit of the time difference Δtn is seconds, and the unit of the speed of light c is meters per second.

The beams L11 to L15 are obtained by separating one laser light L0 into multiple beams. The light emission time ts at which each of the beams L11 to L15 is emitted is the same, and the reception time to at which each of the returned beams R11 to R15 is received varies depending on a given distance to the object 200 that reflects or scatters the beam. With this arrangement, the beams L11 to L15 can be used independently as probe light for determining a distance, so as to correspond to the respective scan laser beams L21 to L25.

The distance information Dat obtained by the distance determining unit 185 is output from the FPGA 180 to the CPU 181 via the lidar I/F 187. The lidar I/F 187 is an example of a distance-information outputting unit that outputs the distance information about the object 200, and the distance information is obtained based on each light reception signal S output from a corresponding APD 8.

The mirror I/F 188 is an interface for controlling the light scanner 120. The CPU 181 is a system controller that supervises the control of the entire controller 140.

The ROS I/F 182 is an interface for transmitting and receiving signals and data to be used between the controller 140 and the external controller 300. The CPU 181 transmits the distance information Dat to the external controller 300 through the ROS I/F 182, and can receive the ranging control signal Ctl from the external controller 300.

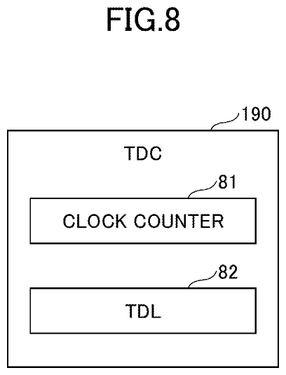

(Detailed configuration of TDC 190) Hereafter, the configuration of the TDC 190 will be described in detail. FIG. 8 is a block diagram illustrating an example of the configuration of the TDC 190. As illustrated in FIG. 8, the TDC 190 has a clock counter 81 and a tapped delay line (TDL) 82. Each of the TDCs 191 to 195 has the configuration illustrated in FIG. 8.

The clock counter 81 is a digital circuit that measures a time length by counting a total number of clock cycles generated by the FPGA 180. The clock counter 81 is an example of a first measuring unit.

An operating clock of the FPGA 180 is about hundreds of megahertz (MHz), and thus a temporal resolution of the clock counter 81 is on the order of several milliseconds. When several nanoseconds in the temporal resolution is converted into a distance, the distance is on the order of tens of centimeters (cm). When measurement variations or the like are considered, accuracy in determining distances with the temporal resolution of the clock counter 81 is further reduced. In this case, the temporal resolution of the clock counter 81 is insufficient because the ranging device such as lidar requires accuracy on the order of several millimeters to a few centimeters.

Therefore, in the present embodiment, the TDL 82, as well as the clock counter 81, are provided. The TDL 82 includes a plurality of delay elements that are coupled in series and are arranged in a direction in which an input signal propagates. The TDL 82 is a digital circuit that measures a time difference based on a total number of delay elements into which the input signal propagates. The TDL 82 is an example of a second measuring unit.

The time taken for a signal to propagate through one delay element may depend on a given device, but is about 100 picoseconds. In this case, with use of the TDL 82, time measurement can be performed on with the temporal resolution on the order of 100 picoseconds or tens of picoseconds that is shorter than the 100 picoseconds, and thus ranging accuracy can be improved in an order of magnitude or more. If only the TDL 82 is used, it is not a practical approach for determining an intermediate distance of about 30 meters, in view of the circuit size of the FPGA. Practically, an intermediate-distance lidar or the like is used to determine the intermediate distance. Therefore, in the present embodiment, by combining the clock counter 81 with the TDL 82, the distance of about 30 meters can be determined with the high distance resolution.

In the present embodiment, each TDC 190 includes the clock counter 81 (first measuring unit) and the TDL 82 (second measuring unit), and outputs time difference information Δt obtained based on measured results obtained by the clock counter 81 and the TDL 82. The clock counter 81 outputs time difference information Δt with the temporal resolution (first temporal resolution) of several nanoseconds, and the TDL 82 outputs time difference information Δt on the order of hundreds of picoseconds or tens of picoseconds (second temporal resolution), which is higher than the temporal resolution of several nanoseconds.

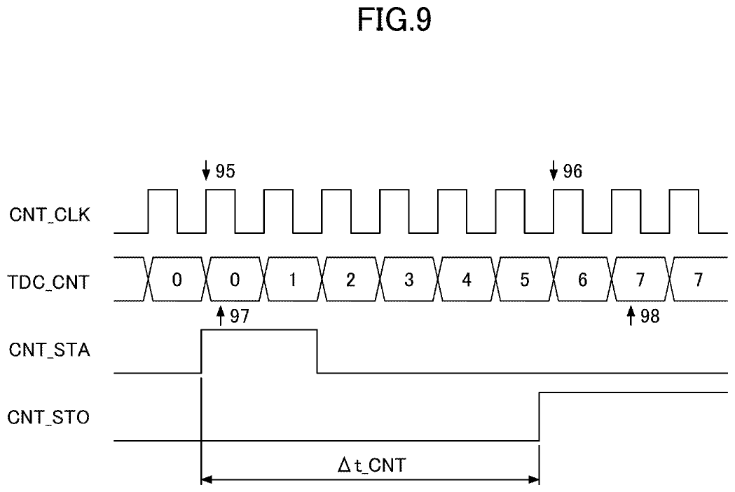

FIG. 9 is a timing chart illustrating an example of time measurement by the clock counter 81. A first part of FIG. 9 illustrates an operational clock signal CNT_CLK of the FPGA 180, and a second part of FIG. 9 illustrates numbers for operational clocks that the clock counter 81 counts. A third part of FIG. 9 illustrates a count start-timing signal CNT_STA that is asserted at the light emission time Ts. A fourth part of FIG. 9 illustrates a count stop-timing signal CNT_STO that is asserted at the light reception time te.

A timing 95 in FIG. 9 is a detection timing obtained at the light emission time ts, and a timing 96 is a detection timing obtained at the light reception time te. A timing 97 is a timing at which the clock counter 81 starts counting, and a timing 98 is a timing at which the clock counter 81 stops counting.

When a greatest clock frequency at which the FPGA 180 operates is 500 MHz, a timing at which the signal is obtained is varied in proportion to a product of a clock and a coefficient of (1+a) at the maximum, and thus measurement accuracy is given by the equation of (1+a)×0.3 (m). Where, a is a constant less than 1.

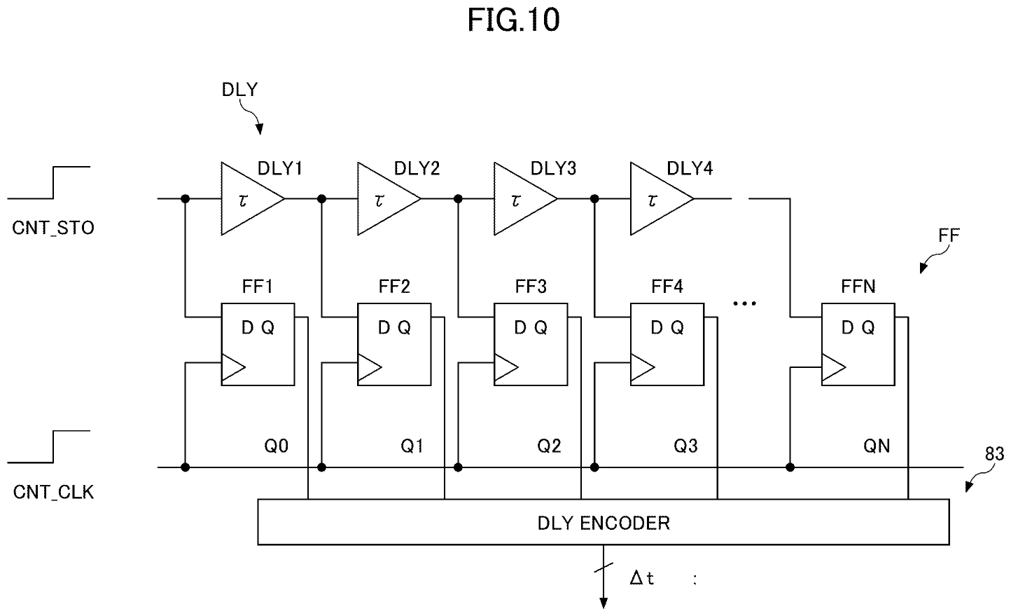

FIG. 10 is a diagram illustrating an example of the configuration of the TDL 82. FIG. 10 illustrates the configuration of a flash TDL that is a simplest configuration applicable to the TDL. As illustrated in FIG. 10, the TDL 82 includes delay elements DLY, flip-flops FFs, and a DLY encoder 83. The delay elements DLY1 to DLY4 are collectively referred to as the delay elements DLY, and the flip-flops FF1 to FFN are collectively referred to as the flip-flops FFs.

As illustrated in FIG. 10, at a later stage of a line along which the stop timing signal CNT_STO as a reference propagates, delay elements DLY1 to DLY4 each of which provides a delay time τ are coupled in series. The delay time τ is shorter than a period of the operational clock of the FPGA 180. The delay time τ is generally less than or equal to 100 picoseconds. The number of delay elements can be appropriately selected.

When the stop timing signal CNT_STO is input to the TDL 82, the stop timing signal CNT_STO propagates in an order of the delay elements DLY1, DLY2, DLY3, and DLY4, and the like.

At a timing at which the operational clock signal CNT_CLK rises, a state of the TDL 82 is input to a corresponding flip-flop FF. The DLY encoder 83 detects a last delay element through which the stop timing signal CNT_STP propagates and that is from all of the delay elements, based on the outputs of the flip-flops FFs, and outputs time difference information Δt indicating a time difference between an input timing of the operational clock signal CNT_CLK and a timing at which the stop timing signal CNT_STO propagates through the last delay element being from all of the delay elements.

The TDL 82 is not limited to the flash TDL illustrated in FIG. 10. A stochastic TDL, a Vernier TDL, or the like can be adopted in order to further increase the temporal resolution.

<Action and effect of ranging device 100> Hereafter, the action and effect of the ranging device 100 will be described.

In recent years, autonomous mobile service robots have been developed and introduced mainly in order to achieve the intended service, e.g., to transport materials in a factory, transport goods and provide guidance at a facility that receives customer service, guard a facility, provide cleaning, or the like. In such a situation, ranging devices such as lidar devices are often used to detect an object that exists in a traveling direction or around a service robot, to thereby create an area map or the like about a facility in which the service robot operates.

As the ranging devices, for example, 2D ranging devices are known to perform scanning while aiming light toward a plane perpendicular to a gravity direction, and to measure a distance to an object existing in the plane. Also, 3D ranging devices are known to perform scanning while aiming light toward the plane perpendicular to the gravity direction, as well as aiming the light in the gravity direction. The 3D ranging devices then measure a distance to an object existing in a 3D space.

The 3D ranging devices are suitable for detecting an object existing in wide 3D ranges to thereby measure a distance to the object. However, structures and control for the devices may be complicated and expensive. For example, it is assumed that the cost for the 3D ranging devices is about 20 to 30 times the cost for the 2D ranging devices. The complicated structures and control for the ranging devices may be one factor in restricting mounting of the ranging devices on service robots, which are at relatively low cost in comparison to other robots.

Also, if a light emitting unit such as a semiconductor laser is used in the ranging device, a time period during which the light emitting unit can emit the light per unit of time (e.g., one second) may be limited, because there is need or the like for lifetime of the light emitting unit or for eye safety.

By limiting the time period during which the light emitting unit can emit light, a greater angle interval at which a given ranging device irradiates an emission area with emission beams may be obtained. If the emission beams are emitted such that a smaller angle interval is obtained, an extent of the emission area may be reduced.

For example, in order to reduce the angle interval at which beams are emitted, it is considered that ranging with respect to the same area is performed multiple times, while shifting a target ranging area used for the ranging device in a direction perpendicular to an emission direction of the beam. However, in this case, because ranging is performed multiple times, a greater time period during which ranging is performed may be obtained. Further, although the number of light emitting units is considered to be increased in order to reduce the angle interval, costs of the ranging device may be increased accordingly.

Therefore, in order to make improvements, ranging is performed in a shorter time period, while reducing device costs. Also, a wider ranging area is used to perform ranging with the high spatial resolution.

In the present embodiment, the ranging device includes the LD 3 (light emitting circuit) configured to emit laser light L0 (light), the grating 41 (splitter) configured to split the light into multiple beams L1, and the light scanner 120 (scanning circuit) configured to perform scanning in two axial directions while aiming the multiple beams toward an emission area 500. The ranging device also includes multiple APDs 8 (light receiving circuits) configured to respectively receive returned beams R2 (beams) obtained from the multiple beams that are reflected or scattered by an object 200 existing in the emission area 500, the APDs being configured to respectively output light reception signals S. The ranging device further includes a lidar I/F 187 (distance-information outputting circuit) configured to output distance information Dat about the object 200, the distance information being obtained based on each of the light reception signals S that is output from a corresponding APD 8 among the multiple APDs 8.

Laser light L0 is separated into multiple beams L1, and the beams L1 into which the laser light is separated are emitted are aimed toward the emission area 500 in order to perform scanning in two axial directions. With this arrangement, a smaller angle interval Pw (see FIG. 1) at which the ranging device 100 irradiates the emission area 500 with beams L2 can be obtained. For example, when the laser light L0 is separated into five beams each of which travels in a predetermined direction, scan laser beams L2 can be aimed in predetermined directions toward a predetermined emission area 500, at angle intervals Pw that are each at one-fifth an angle interval obtained in a case in which the laser light L0 is not separated. With this arrangement, the spatial resolution corresponding to the angle intervals Pw is obtained, and thus a wider ranging area can be used to determine a given distance with the high spatial resolution.

When one laser light L0 is separated into multiple beams L1, the beams L1 into which the light is separated are obtained at approximately the same timing, and thus scan laser beams L2 can be respectively aimed at different locations. The distance information Dat can be obtained for each location at which the scan laser beam L2 is aimed, and thus an increased number of pieces of distance information Dat used for performing ranging can be obtained per unit of time. With this arrangement, the number of measurement results indicating the respective pieces of distance information Dat can be increased by the number of beams L2 into which the laser light L0 is separated. As a result, a measurement result group consisting of the increased number of pieces of distance information Dat can be obtained in a shorter time period. Further, when the increased number of measurement results is obtained, a device cost per unit of measurement result that is obtained by dividing the cost of the ranging device 100 by a total number of measurement results can be reduced.

In the present embodiment, multiple beams L2 (multiple beams aimed by the scanning circuit) include a scan laser beam L21 (first beam) and a scan laser beam L22 (second beam). The multiple APDs 8 (light receiving circuits) include an APD 81 (first light receiving circuit) and an APD 82 (second light receiving circuit). The APD 81 receives a returned beam R11 obtained from the scan laser beam that is reflected or scattered by the object 200 to thereby output a light reception signal S1. The APD 82 receives a returned beam R12 obtained from the scan laser beam that is reflected or scattered by the object 200 to thereby output a light reception signal S2.

With this arrangement, for each of beams into which the laser light is separated, distance information Dat can be obtained based on a corresponding light reception signal S from the APD 8. Thus, the number of measurement results can be increased.

In the present embodiment, the ranging device further includes multiple TDCs 190 (time difference-information outputting circuits), and each TDC outputs time difference information Δt between a first time at which the LD 3 emits the laser light L0 and a second time at which a corresponding APD 8 receives a beam obtained from a given beam that is reflected or scattered by the object 200. Each TDC 190 outputs distance information Dat about the object 200, the distance information Dat being obtained based on corresponding time difference information Δt.

The APDs 8 includes an APD 81 and an APD 82. The TDCs 190 includes a TDC 191 (first time-difference information outputting circuit) and a TDC 192 (second time-difference information outputting circuit). The TDC 191 outputs time difference information Δt1 that is based on the light reception signal S1 output from the APD 81, and the TDC 192 outputs time difference information Δt2 that is based on the light reception signal S2 output from the APD 82.

With this arrangement, light reception signals S, from the APDs 8, that correspond to beams into which the light is separated can be processed in parallel to thereby obtain pieces of distance information Dat, respectively. Thus, an increased number of measurement results can be obtained faster.

In the present embodiment, each of the TDCs 191 to 195 (multiple time-difference information outputting circuits) includes a clock counter 81 (first measuring circuit) and a TDL 82 (second measuring circuit). Each TDC outputs time difference information Δt that is based on measured results by the clock counter 81 and the TDL 82. The clock counter 81 outputs time difference information Δt with a temporal resolution (first temporal resolution) of several nanoseconds. The TDL 82 outputs time difference information Δt with a temporal resolution (second temporal resolution) on the order of hundreds of picoseconds or tens of picoseconds, which is higher than the time resolution of the several nanoseconds.

The clock counter 81 outputs time difference information Δs obtained by counting a number of clock cycles that are generated by the FPGA 180 (calculator). The TDL 82 includes a plurality of delay elements DLY coupled in series so as to be arranged in a propagation direction of the finish timing signal CNT_STO (input signal). The TDL 82 outputs time difference information Δt that is obtained based on a total number of the delay elements DLY through which the input signal propagates.

With this arrangement, ranging can be performed to determine a distance of about 30 meters with the high distance resolution.

In the present embodiment, the light scanner 120 includes the polygon mirror 5 and the rotary stage 10. However, the light scanner 120 is not limited to this example. When scanning can be performed by light, any configuration may be adopted. For example, the light scanner 120 may include a MEMS mirror, a Galvano mirror, or the like with which scanning can be performed in two axial directions. In this case, the action and effect similar to the action and effect described for the ranging device 100 are obtained.

In the present embodiment, the FPGA 180 is illustrated as a calculator, but the calculator may be implemented by an ASIC.

In conventional TDCs such as TDC integrated circuits (ICs), a total number of signals that can be processed is limited to two, four, or the like. However, according to the present embodiment, multiple TDCs are implemented by a single digital circuit. In this case, an increased number of beams L1 into which laser light L0 is separated can be obtained to an extent to which the circuit size is permitted, and thus a total number of measurement results can be increased accordingly.

In conventional ranging devices with a plurality of light receiving units, the number of digital signal processing circuits is one, and thus multiple measurement results are not obtained simultaneously. In contrast, in the present embodiment, a plurality of digital processing circuits are respectively provided with respect to the plurality of light receiving units, and thus the number of measurement results that are processed in parallel can be increased.

(Comparison with other systems) Comparison between a ranging system according to the present embodiment and other ranging systems will be described below.

First, a flash 3D lidar device that emits pulsed light of which an emission range is expanded to an emission area 500 will be compared with the ranging device according to the present embodiment. The ranging device 100 irradiates the emission area 500 with scan laser beams L2, and thus emission beams can be propagated over a long distance, while reducing beam attenuation. Accordingly, the ranging device 100 advantageously has an emission range of long distances in which ranging can be performed, in comparison to the flash 3D lidar device in which the beams are likely to be attenuated due to the beams propagating over a long distance. In the present embodiment, the spatial resolution can be improved by increasing a total number of measurement results per unit of angle, while ensuring the advantage described above.

In the present embodiment, the scan laser beams L2 are emitted in two axial directions, in accordance with rotation of the polygon mirror 5 and the rotary stage 10. With this arrangement, beams can be emitted in a wide angle range, in comparison to a case in which the flash 3D lidar device is used.

The ranging device 100 according to the present embodiment is a coaxial lidar device in which returned beams R2 that are respectively obtained from scan laser beams L2 reflected from a predetermined surface of the polygon mirror 5 are reflected from the same predetermined surface of the polygon mirror 5, and then the resulting beams are respectively received by the APDs 8. When the coaxial lidar device is used as each of multiple ranging devices, the coaxial lidar device has an advantage of allowing for reductions in crosstalk between the ranging devices. In the present embodiment, crosstalk can be reduced in comparison to a case in which the flash 3D lidar device is used.

Hereafter, the ranging device according to the present embodiment will be compared with a scanning 3D lidar device in which light emitted by a light emitting unit is emitted in a scan in which light is not separated. In the present embodiment, a total number of measurement results can be increased by separating the laser light L0, thereby reducing the time taken to obtain a required number of measurement results. Thus, when the ranging device 100 is provided in a given service robot, the effect of securing an appropriate response time for an obstacle around the given service robot can be obtained.

In the 3D lidar device, if the number of light emitting units is increased in order to increase the number of measurement results, the manufacturing cost of the 3D lidar device may increase, because the cost of the light emitting units such as lasers is expensive.

When a 3D lidar device has a number of N light emitting units and one light receiving unit, these light emitting units need to emit light sequentially one by one such that a plurality of returned lights does not enter the light receiving unit simultaneously, and thus the number of measurement results per unit of time may be limited. If multiple light receiving units are provided in order to mitigate the limitation to the number of measurement results, device costs may be increased.

In contrast, according to the present embodiment, the cost of the ranging device 100 can be reduced, because the number of measurement results is increased by increasing the number of light receiving units, such as APDs that are relatively inexpensive, without increasing the number of light emitting units.

Although one or more embodiments have been described above, the present disclosure is not limited to the particulars of the described embodiments. Modifications or changes can be made without departing from the scope defined in the present disclosure.

For example, a given moving body provided in the ranging device 100 is not limited to the service robot. For example, the moving body may include (i) a land vehicle such as an automobile, a wheel vehicle, an electric train, a steam train, or a forklift, (ii) an aerial vehicle such as an airplane, a balloon, or a drone, or (iii) a marine vehicle such as a hovercraft, a ship, a steamer, or a boat.

The light that the ranging device 100 emits in a scan is not limited to laser light, and light with no directivity may be used. Electromagnetic waves having a longer wavelength, such as radar, can be used as a type of light.

One or more embodiments include a method for determining a distance. For example, such a method is executed by a ranging device. The ranging device includes (i) a light emitting circuit configured to emit light, (ii) a splitter configured to split the light into multiple beams, (iii) a scanning circuit configured to perform scanning in two axial directions while aiming the beams toward an emission area, and (iv) multiple light receiving circuits configured to respectively receive beams obtained from the multiple beams that are reflected or scattered by an object existing in the emission area, the light receiving circuits being configured to respectively output light reception signals. The method includes outputting pieces of time difference information that are each between a first time at which the light emitting circuit emits the light and a second time at which a corresponding light receiving circuit receives a beam obtained from a given beam among the multiple beams that are reflected or scattered by the object. The method also includes outputting distance information that is obtained based on each of the pieces of output time difference information. The outputting of the pieces of time difference information includes (i) outputting time difference information that is obtained based on a light reception signal output from a first light receiving circuit among the multiple light receiving circuits, and (ii) outputting time difference information that is obtained based on a light reception signal output from a second light receiving circuit among the multiple light receiving circuits. By such a method, effects can be obtained as in the aforementioned ranging device.

The numbers, such as ordinal numbers, or quantities described in the embodiments are all examples for purposes of illustrating the techniques specifically described in the present disclosure, and the present disclosure is not limited to these examples. The connections among components are examples for the purpose of illustrating the technique specifically described in the present disclosure, and is not limited to the example.

What is claimed is:

1. A ranging device comprising:
a light emitting circuit configured to emit light;
a splitter configured to split the light into multiple beams;
a scanning circuit configured to perform scanning in two axial directions while aiming the multiple beams toward an emission area;
multiple light receiving circuits configured to respectively receive beams obtained from the multiple beams that are reflected or scattered by an object existing in the emission area, the light receiving circuits being configured to respectively output light reception signals; and
a distance-information outputting circuit configured to output distance information about the object, the distance information being obtained based on each of the light reception signals that is output from a corresponding light receiving circuit among the multiple light receiving circuits.

2. The ranging device according to claim 1, wherein the multiple beams aimed by the scanning circuit include a first beam and a second beam,
wherein the multiple light receiving circuits include
a first light receiving circuit configured to receive a beam obtained from the first beam that is reflected or scattered by the object to thereby output a light reception signal, and
a second light receiving circuit configured to receive a beam obtained from the second beam that is reflected or scattered by the object to thereby output a light reception signal.

3. The ranging device according to claim 1, further comprising multiple time difference-information outputting circuits, each time difference-information circuit being configured to output time difference information between a first time, at which the light emitting circuit emits the light, and a second time, at which a corresponding light receiving circuit receives a beam obtained from a given beam that is reflected or scattered by the object,
wherein the distance-information outputting circuit is configured to output the distance information about the object, the distance information being obtained based on given time difference information output,
wherein the multiple light receiving circuits include
a first light receiving circuit configured to receive a beam obtained from a first beam, among the multiple beams aimed by the scanning circuit, that is reflected or scattered by the object, to thereby output a light reception signal, and
a second light receiving circuit configured to receive a beam obtained from a second beam, among the multiple beams aimed by the scanning circuit, that is reflected or scattered by the object, to thereby output a light reception signal, and
wherein the multiple time difference-information outputting circuits include
a first time difference-information outputting circuit configured to output time difference information obtained based on the light reception signal output from the first light receiving circuit, and
a second time difference-information outputting circuit configured to output time difference information obtained based on the light reception signal output from the second light receiving circuit.

4. The ranging device according to claim 3, wherein each of the multiple time difference-information outputting circuits includes
a first measuring circuit configured to output second time difference information with a first temporal resolution, and
a second measuring circuit configured to output third time difference information with a second temporal resolution that is higher than the first temporal resolution, and
wherein each of the time difference-information outputting circuits is configured to output corresponding time difference information based on measured results by the first measurement circuit and the second measurement circuit, the measured results including the second time difference information and the third time difference information.

5. The ranging device according to claim 4, wherein the first measuring circuit is configured to operate with a clock signal, the first measuring circuit being configured to output the second time difference information that is obtained by counting a total number of clock cycles generated between the first time and the second time, and
wherein the second measuring circuit includes multiple delay circuits coupled in series so as to be arranged in a propagation direction of an input signal, the second measuring circuit being configured to output the third time difference information obtained based on a total number of delay circuits through which the input signal propagates.

6. A method for determining a distance, the method being executed by a ranging device, the ranging device including
a light emitting circuit configured to emit light;
a splitter configured to split the light into multiple beams;
a scanning circuit configured to perform scanning in two axial directions while aiming the beams toward an emission area; and
multiple light receiving circuits configured to respectively receive beams obtained from the multiple beams that are reflected or scattered by an object existing in the emission area, the light receiving circuits being configured to respectively output light reception signals, the method comprising:
outputting pieces of time difference information that are each between a first time at which the light emitting circuit emits the light and a second time at which a corresponding light receiving circuit receives a beam obtained from a given beam among the multiple beams that are reflected or scattered by the object;
outputting distance information that is obtained based on each of the pieces of output time difference information,
wherein the outputting of the pieces of time difference information includes
outputting time difference information that is obtained based on a light reception signal output from a first light receiving circuit among the multiple light receiving circuits, and
outputting time difference information that is obtained based on a light reception signal output from a second light receiving circuit among the multiple light receiving circuits.
